(19) United States
(12) Patent Application Publication
(10) Pub. No.: US 2024/0084967 A1
(43) Pub. Date: Mar. 14, 2024

(54) PRESSURE VESSEL

(71) Applicant: SUNG woo HITECH CO., LTD., Busan (KR)

(72) Inventors: Jung Han LEE, Ulsan (KR); Sang Eon PARK, Busan (KR); Sung Man SOHN, Yangsan-si (KR)

(21) Appl. No.: 17/984,311

(22) Filed: Nov. 10, 2022

(30) Foreign Application Priority Data
Sep. 8, 2022 (KR) 10-2022-0113974

(51) Int. Cl. F17C 1/00

(52) U.S. Cl. CPC F17C 1/00; F17C 2201/0109; F17C 2203/0604; F17C 2203/0619; F17C 2203/0639; F17C 2203/0646; F17C 2203/066; F17C 2205/0305; F17C 2221/011; F17C 2221/012; F17C 2221/014; F17C 2221/033

(57) ABSTRACT

To improve productivity and sealing performance, the present disclosure provides a pressure vessel including a boss part including a boss extension portion that is provided in a cylindrical shape, a boss flange portion integrally extending from a lower portion of the boss extension portion, and a boss support portion integrally extending from an inner end of the boss flange portion, a fusion-coupling part insert-injected in a form surrounding an outer surface of one side of the boss support portion in the circumferential direction, and a liner part which has an accommodation space for accommodating a fluid therein, extends in a longitudinal direction, and has both open sides, and the liner part is made of the same material as the fusion-coupling part, and both inner circumferences of the liner part are in surface contact with and fusion-coupled to an outer circumference of the fusion-coupling part.

### CROSS-REFERENCE TO RELATED APPLICATION

This application claims priority to and the benefit of Korean Patent Application No. 10-2022-0113974 filed on Sep. 8, 2022, the disclosure of which is incorporated herein by reference in its entirety.

### BACKGROUND

### 1. Field of the Invention

The present disclosure relates to a pressure vessel, and more particularly, to a pressure vessel having improved productivity and improved sealing performance.

### 2. Discussion of Related Art

In general, gas storage vessels are required to store various types of gases, such as hydrogen, nitrogen, and natural gas, and to discharge the stored gases as needed. In particular, since the storage density of gas in the vessel is low, the gas needs to be stored at a high pressure, and a pressure vessel is essential for use in such a high pressure environment.

For example, alternative fuel gas vehicles including fuel cell vehicles or compressed natural gas vehicles have different structures for a storage system according to a storage method of a fuel gas. Further, in recent years, a compressed gas type storage method is spotlighted in consideration of a unit cost, a weight, and simplicity of the storage system. However, since a gaseous fuel has a low energy storage density, a storage amount should be increased or a storage pressure should be increased to secure long-distance driving. In particular, in the case of a vehicle, since a space for mounting a gas storage system is limited, there is a limit to increasing the size of a storage tank, and thus to safely store a gas having a higher pressure is the core of a tank technology.

Further, in the case of a composite tank among fuel gas storage tanks, to manage an internal pressure caused by compressed gas, an outer cover is reinforced with a fiber-reinforced composite material having high specific strength and specific stiffness, and a liner that maintains airtightness is inserted into the composite tank. In this case, the fuel gas storage tanks are divided into different types according to a material of the liner, a tank into which a liner made of a metal material such as aluminum is inserted is classified as Type 3, and a tank into which a high-density polymer liner is inserted is classified as Type 4.

In detail, in the case of Type 3, although stability is relatively high, the tank is expensive and has a low fatigue resistance property. On the other hand, the Type 4 tank is cheaper than the Type 3 tank, has an excellent fatigue resistance property, but has safety problems such as leakage of hydrogen and a low permeability resistance property. In particular, since a metal nozzle applied for mounting an external valve and a plastic material of a body are different, the airtightness of a boss extension portion is important.

Here, in the liner made of a high-density polymer material, an upper liner constituting an upper portion of the pressure vessel and a lower liner constituting a lower portion thereof are separately manufactured and fusion-bonded to each other.

However, conventional liners have a serious problem in that a gas such as hydrogen stored in the pressure vessel leaks through a gap formed between the upper liner and the lower liner fusion-bonded to each other.

In particular, during laser welding for the fusion bonding between the upper liner and the lower liner, a gap is formed due to lifting occurring between the upper liner and the lower liner. Accordingly, a fluid stored inside the pressure vessel leaks along the gap.

To solve this, since a separate jig for supporting the upper liner and the lower liner is required during the laser welding between the upper liner and the lower liner, a manufacturing process is complicated and productivity is degraded.

Moreover, even after the upper liner and the lower liner are welded to each other, when the pressure vessel is pressed by an external pressure, a coupling surface therebetween is deformed, a gap is generated, and thus the fluid filling the liner leaks.

Thus, there is an urgent need for research to improve a bonding force between the liners to prevent non-ideal leakage of the fluid filling the liner.

### RELATED ART DOCUMENT

[Patent Document]
Korean Patent Registration No. 10-1806643

### SUMMARY OF THE INVENTION

The present disclosure is directed to providing a pressure vessel having improved productivity and improved sealing performance.

The present disclosure provides a pressure vessel including a boss part including a boss extension portion that is provided in a cylindrical shape and has a fastening screw thread formed on an outer circumference thereof, a boss flange portion integrally extending radially outward in a circumferential direction from a lower portion of the boss extension portion, and a boss support portion integrally extending downward in a longitudinal direction from an inner end of the boss flange portion, and having a through-hole formed in a central portion thereof in the longitudinal direction, a fusion-coupling part insert-injected in a form surrounding an outer surface of one side of the boss support portion in the circumferential direction, and a liner part which has an accommodation space for accommodating a fluid therein, extends in a longitudinal direction, and has both open sides and in which both ends of the liner part are in close contact with and coupled to a lower outer edge of the boss flange portion, both inner circumferences of the liner part face with a gap therebetween and are inserted into an outer circumference of the boss support portion, the liner part is made of the same material as the fusion-coupling part, and both inner circumferences of the liner part are in surface contact with and fusion-coupled to an outer circumference of the fusion-coupling part.

The present disclosure also provides a pressure vessel including a boss part including a boss extension portion that is provided in a cylindrical shape and has a fastening screw thread formed on an outer circumference thereof, a boss flange portion integrally extending radially outward in a circumferential direction from a lower portion of the boss extension portion, a boss support portion integrally extending downward in a longitudinal direction from an inner end of the boss flange portion, and a sealing coupling portion integrally extending downward from the boss support portion in the longitudinal direction and having a sealing groove formed on an outer circumference of the sealing coupling portion to be recessed radially inward in the circumferential direction, and having a through-hole formed in a central portion thereof in the longitudinal direction, a fusion-coupling part insert-injected in a form surrounding an outer surface of one side of the boss support portion in the circumferential direction, a liner part which has an accommodation space for accommodating a fluid therein, extends in a longitudinal direction, and has both open sides and in which both ends of the liner part are in close contact with and coupled to a lower outer edge of the boss flange portion, both inner circumferences of the liner part face with a gap therebetween and are inserted into an outer circumference of the boss support portion, the inner circumferences of the liner part face and are spaced apart from an outer circumference of the sealing coupling portion, the liner part is made of the same material as the fusion-coupling part, and both inner circumferences of the liner part are in surface contact with and fusion-coupled to an outer circumference of the fusion-coupling part, a sealing part which is provided in a ring shape and of which an inner circumference is inserted into the sealing groove and an outer circumference is sealing-coupled to the inner circumferences of the liner part, and a composite cover part that is sealing-coupled to an outer circumference of the liner part while surrounding outer surfaces of the boss extension portion and the boss flange portion.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a cross-sectional view illustrating a pressure vessel according to an embodiment of the present disclosure;

FIG. 2 is an exemplary cross-sectional view illustrating a coupling relationship between a liner part and a boss part in the pressure vessel according to the embodiment of the present disclosure; and

FIG. 3 is a cross-sectional view illustrating the boss part in the pressure vessel according to the embodiment of the present disclosure.

### DETAILED DESCRIPTION OF EXEMPLARY EMBODIMENTS

Hereinafter, a pressure vessel according to exemplary embodiments of the present disclosure will be described in detail with reference to the accompanying drawings.

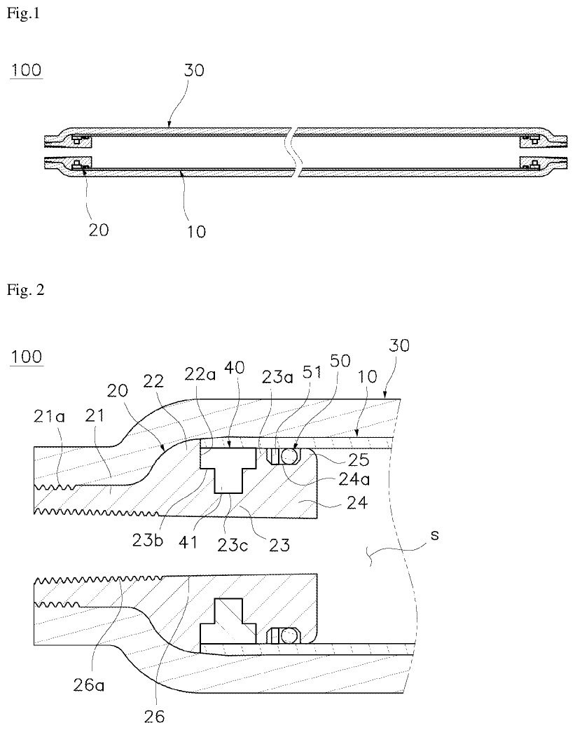

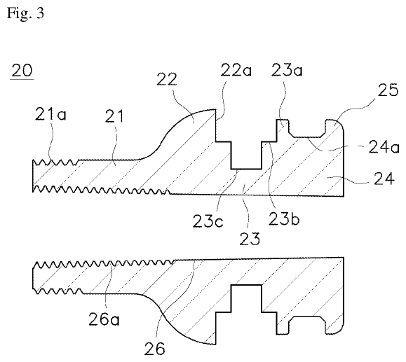

FIG. 1 is a cross-sectional view illustrating a pressure vessel according to an embodiment of the present disclosure, FIG. 2 is an exemplary cross-sectional view illustrating a coupling relationship between a liner part and a boss part in the pressure vessel according to the embodiment of the present disclosure, and FIG. 3 is a cross-sectional view illustrating the boss part in the pressure vessel according to the embodiment of the present disclosure.

As illustrated in FIGS. 1 to 3, a pressure vessel 100 according to the embodiment of the present disclosure includes a liner part 10, a boss part 20, and a fusion-coupling part 40.

Here, the pressure vessel 100 is a vessel used for storing various fluids such as oxygen, natural gas, nitrogen, and hydrogen therein, and may be provided so that the fluid is selectively introduced and discharged repeatedly. In this case, the fluid may be stored inside the pressure vessel 100 at a high pressure of 700 bar.

Further, it is preferable that the liner part 10 be insert-injected or extruded to form an accommodation space s in which the fluid is accommodated, extend in a longitudinal direction, and have both open sides.

In this case, it is preferable that the liner part 10 be provided in a vessel shape and the accommodation space s communicating with a through-hole 26 formed to pass through the boss part 20 be formed such that the fluid is accommodated therein.

Further, the boss parts 20 may be sealing-coupled to both ends of the liner part 10. In this case, it is preferable that both ends of the liner part 10 be in close contact with and coupled to an outer edge of a lower end of a boss flange portion 22 which will be described below. Of course, in some cases, one end of the liner part may be sealed in a vessel shape and the other end of the liner part 10 may be open so that the boss part 20 can be sealing-coupled. Further, it is most preferable that the liner part 10 be made of a synthetic resin material including polyamide.

In addition, it is preferable that both inner circumferences of the liner part 10 face with a gap therebetween and be inserted into an outer circumference of a boss support portion 23 which will be described below, the liner part 10 be made of the same material as the fusion-coupling part 40, and both inner circumferences of the liner part 10 be in surface contact with and fusion-coupled to an outer circumference of the fusion-coupling part 40.

Meanwhile, it is preferable that the boss part 20 include a boss extension portion 21, the boss flange portion 22, and the boss support portion 23 that are formed integrally with each other. Here, the boss part 20 may be manufactured by processing steel or aluminum, and the material is not limited thereto.

Further, it is preferable that the through-hole 26 be formed to pass through a center of the boss part 20 in a longitudinal direction. In this case, it is preferable that an upper side of the through-hole 26 be open in an upward direction of the boss part 20 and a lower side of the through-hole 26 be open in a downward direction of the boss part 20 so that the through-hole 26 communicates with the accommodation space s of the liner part 10. In addition, a screw thread 26a may be formed on an upper inner circumferential surface of the through-hole 26 so that the screw thread 26a is screw-coupled to an external device (not illustrated) to prevent leakage of the fluid when the fluid is introduced into the pressure vessel 100 and the fluid is discharged to the outside of the pressure vessel 100. In this case, the external device (not illustrated) may include a sealing device (not illustrated) for sealing the through-hole 26 and a valve device (not illustrated) for allowing the fluid to be introduced into or discharged from the pressure vessel 100. Further, the through-hole 26 may be formed so that an inner diameter thereof increases from the upper side to the lower side. In this case, it is preferable that a portion illustrated on a left side of FIG. 2 be understood as upper sides of the boss part 20 and the through-hole 26, and it is preferable that a portion illustrated on a right side of FIG. 2 be understood as lower sides of the boss part 20 and the through-hole 26.

Further, it is preferable that the boss extension portion 21 be provided in a cylindrical shape, a fastening screw thread 21a be formed on an outer circumference of the boss extension portion 21, and the through-hole 26 be formed to pass through a central portion of the boss extension portion 21.

In addition, it is preferable that the boss flange portion 22 integrally extend radially outward in a circumferential direction at a lower portion of the boss extension portion 21 and both ends of the liner part 10 be in close contact with and coupled to a lower outer edge of the boss flange portion 22. In this case, it is preferable to understand that the through-hole 26 is formed to pass through a central portion of the boss flange portion 22.

Here, it is preferable to understand that the boss extension portion 21 and the boss flange portion 22 are integrally formed with each other, the boss extension portion n21 is formed on an upper side of the boss part 20, and the boss flange portion 22 is formed on a lower side of the boss part 20. In this case, as an upper end of the boss extension portion 21 is close to a boundary region with the lower boss flange portion 22, an outer surface of the boss extension portion 21 may be formed to extend more linearly.

Further, as a boundary region with the upper boss extension portion 21 is close to a lower end of the boss flange portion 22, an upper surface of the boss flange portion 22 may be formed to extend more radially outward in the circumferential direction.

Meanwhile, it is preferable that the boss support portion 23 integrally extend downward in a longitudinal direction from an inner end of the boss flange portion 22 and an outer circumference of the boss support portion 23 be inserted into both inner circumferences of the liner part 10 while both inner circumferences of the liner part face with a gap therebetween. In this case, it is preferable to understand that the through-hole 26 is formed to pass through a central portion of the boss support portion 23.

Here, it is preferable that the boss support portion 23 integrally extend in a longitudinal direction of the liner part 10 perpendicular to a laser radiation direction from the inner end of the boss flange portion 22 to be parallel to the liner part 10 of the boss flange portion 22.

Further, it is preferable that a stepped portion 22a is formed to be stepped in a boundary region between the boss flange portion 22 and the boss support portion 23. That is, both ends of the liner part 10 in the longitudinal direction may be in close contact with and coupled to the stepped portion 22a.

In this case, the stepped portion 22a may be formed along the lower outer edge of the boss flange portion 22, and a radial length of the stepped portion 22a may be set to correspond to the thickness of the liner part 10. Thus, the liner part 10 and the boss flange portion 22 may be formed to have a mutually continuous outer contour. Thus, a composite cover part 30, which will be described below, may be sealing-coupled to an outer circumference of the liner part 10 while surrounding the outer surfaces of the boss extension portion 21 and the boss flange portion 22 with a continuous outer contour.

Further, it is preferable that a length of the boss support portion 23 is set to exceed a length of the fusion-coupling part 40. Further, it is preferable that a catching protrusion 23a be formed at a lower end of the boss support portion 23 to extend radially outward in the circumferential direction with a thickness corresponding to the fusion-coupling part 40 such that a lower end of the fusion-coupling part 40 is caught by and coupled to the catching protrusion 23a.

In this case, an accommodation groove 23b may be formed to be recessed radially inward in a circumferential direction of the boss support portion 23 in an outer circumferential surface of the boss support portion 23 formed between the stepped portion 2a and the catching protrusion 23a. In this case, the length of the accommodation groove 23b may be set to correspond to a longitudinal length of the fusion-coupling part 40. Further, a radial recessed depth of the accommodation groove 23b may be set to correspond to a radial thickness of the fusion-coupling part 40. Further, the accommodation groove 23b may be set to mesh with and correspond to a contour of an inner surface of the fusion-coupling part 40. Accordingly, the fusion-coupling part 40 may be provided to surround the accommodation groove 23b, a lower end of the fusion-coupling part 40 is caught by and coupled to the catching protrusion 23a, stable fixing is achieved during laser welding, and thus the precision in the fusion-coupling can be significantly improved.

In addition, a recessed groove 23c may be formed in the boss support portion 23 to be recessed radially inward from an outer circumference of the accommodation groove 23b in the circumferential direction.

In addition, the fusion-coupling part 40 may be provided in a ring shape, and a shape engagement protrusion 41 may protrude radially inward in a circumferential direction from an inner circumference to mesh with the recessed groove 23c. In this case, it is preferable that the shape engagement protrusion 41 is formed in a contour corresponding to the contour of the recessed groove 23c.

Accordingly, the shape engagement protrusion 41 meshes with the recessed groove 23c, the fusion-coupling part 40 is stably fixed to the liner part 10 when the liner part 10 and the fusion-coupling part 40 are fusion-coupled to each other, and thus a coupling force therebetween can be significantly improved.

Meanwhile, it is preferable that the boss part 20 include a sealing coupling portion 24 which integrally extends from the boss support portion 23 in the longitudinal direction and in which an outer circumference of the sealing coupling portion 24 faces and is spaced apart from the inner circumference of the liner part 10 and the through-hole 26 communicates with an inside of the sealing coupling portion 24. In this case, it is preferable to understand that the through-hole 26 is formed to pass through an internal central portion of the sealing coupling portion 24.

Here, a sealing groove 24a may be formed in the outer circumference of the sealing coupling portion 24 to be recessed radially inward in the circumferential direction.

Further, it is preferable that a sealing stepped portion 25 which protrudes radially outward in the circumferential direction and of which an outer circumference faces the inner circumferences of the liner part 10 be formed at a lower end of the sealing coupling portion 24. In this case, it is preferable to understand that the sealing stepped portion 25 is formed at a lowermost end of the boss part 20, and it is preferable to understand that the through-hole 26 is formed to pass through a central portion of the sealing stepped portion 25.

In addition, it is preferable that the pressure vessel 100 according to the embodiment of the present disclosure further include sealing parts 50 and 51 which are provided in a ring shape and of which inner circumferences are inserted into the sealing grooves 24a and outer circumferences are sealing-coupled to the inner circumferences of the liner part 10.

In this case, at least one sealing part 50 and 51 may be provided, and the radial thickness of the sealing part 50 may be set to slightly exceed a recessed depth of the sealing groove 24a to be in close contact with the liner part 10.

Further, when a plurality of sealing parts 50 and 51 are provided, the sealing parts 50 and 51 may be sealing-coupled to the sealing grooves 24a while in close contact with each other in a longitudinal direction of the sealing coupling portion 24. For example, the sealing parts 50 and 51 may include a first sealing part 50 provided in a ring shape and having a rounded outer contour and a second sealing part 51 provided in a ring shape having a rectangular cross section. In this case, the sum of the thicknesses of the sealing parts 50 and 51 in the longitudinal direction may be set to correspond to the length of the sealing groove 24a.

In addition, a sealing protrusion (not illustrated) continuously protruding outward along a circumference may be integrally formed on an outer surface of at least one of the sealing parts 50, and the sealing protrusion (not illustrated) may be sealing-coupled to the inner circumferences of the liner part 10.

Accordingly, the outer circumferences of the sealing parts 50 and 51 provided in the sealing coupling portion 24 integrally extending downward from the boss support portion 23 in the longitudinal direction may be sealing-coupled to the inner circumferences of the liner part 10. Accordingly, both the fusion-coupling caused by the fusion-coupling part 40 and the sealing are formed in both inner circumferences of the liner part 10, and thus the sealing performance can be significantly improved.

Further, lower ends of the sealing parts 50 and 51 are caught by and coupled to the sealing stepped portions 25 protruding radially outward from the lower end of the sealing coupling portion 24 in the circumferential direction, and thus separation can be prevented and stable sealing performance can be provided.

Meanwhile, it is preferable that the fusion-coupling part 40 be insert-injected in a ring shape to surround an outer surface of one side of the boss support portion 23 in the circumferential direction, and an outer circumference of the fusion-coupling part 40 be in surface contact with and fusion-coupled to both inner circumference of the liner part 10.

Here, the fusion-coupling part 40 may be formed of the same material as the liner part 10, and the liner part 10 may be provided with a color having a higher brightness than the fusion-coupling part 40. In this case, preferably, the liner part may be provided in white, and the fusion-coupling part 40 may be provided in black. For example, the entire liner part 10 may be provided with a color having a higher brightness than the fusion-coupling part 40. Of course, in some cases, only both sides of the liner part 10 in the longitudinal direction may be partially provided with a color having a higher brightness than the fusion-coupling part 40.

For example, the liner part 10 may be provided in white so that a laser beam is transmitted therethrough, and the fusion-coupling part 40 may be provided in black so that an outer surface of the fusion-coupling part 40 absorbs heat and is heated and fused when a laser beam is radiated. Alternatively, the liner part 10 may be transparent, and the fusion-coupling part 40 may be provided in black.

Therefore, both inner circumferences of the liner part 10 in the longitudinal direction and the outer circumference of the fusion-coupling part 40 may be in surface contact with each other. Next, when a laser beam is transmitted from a laser radiation device (not illustrated) that radiates a laser beam from the outside in a radial direction in the circumferential direction of the liner part 10 and reaches the fusion-coupling part 40, mutual fusion-coupling can be performed. In this case, as a boundary region between the inner circumferences of the liner part 10 and the outer circumference of the fusion-coupling part 40 is fused and then hardened, a fusion-coupling surface can be formed in the boundary region between the inner circumferences of the liner part 10 and the outer circumference of the fusion-coupling part 40.

Thus, the liner part 10 formed of a mutually homogeneous material and provided in white or with a transparent color having a higher brightness than the fusion-coupling part 40 provided in black color overlaps the fusion-coupling part 40 in the radial direction.

Accordingly, when the laser beam transmitted through both inner circumferences of the liner part 10 in the longitudinal direction and the outer circumference of the fusion-coupling part 40, which are in surface contact with each other, is absorbed to heat the fusion-coupling part 40, the fusion-coupling is precisely performed, and thus work convenience can be significantly improved.

Here, unlike the related art in which a support roller (not illustrated) for supporting an inner boundary region between an upper liner part (not illustrated) and a lower liner part (not illustrated) divided from each other is required during the laser welding, the rigid boss support portion 23 made of a metal material supports the fusion-coupling part 40.

Meanwhile, the pressure vessel 100 according to the embodiment of the present disclosure may further include the composite cover part 30 sealing-coupled while simultaneously surrounding the outer circumference of the liner part 10 and the outer surfaces of the boss extension portion 21 and the boss flange portion 22. That is, it is preferable that the composite cover part 30 is provided to be in close contact with and cover the outer circumference of the liner part 10 and the outer surfaces of the boss extension portion 21 and the boss flange portion 22 while surrounding the same.

The composite cover part 30 may be provided by impregnating a reinforcement fiber such as carbon fiber, glass fiber, or synthetic polyamide fiber with a resin such as an epoxy resin. Accordingly, the composite cover part 30 may be wound around or stacked on the outer circumference of the liner part 10 and the outer surfaces of the boss extension portion 21 and the boss flange portion 22 with a predetermined thickness. Therefore, as the composite cover part 30 is wound around or stacked on the outer circumference of the liner part 10 and the outer surfaces of the boss extension portion 21 and the boss flange portion 22, the pressure resistance of the accommodation space s formed inside the liner part 10 can be improved.

In this way, in the present disclosure, when the fusion-coupling part 40 and the liner part 10 insert-injected in a form surrounding the boss support portion 23 are fusion-coupled to each other, the fusion-coupling part 40 is supported by the boss support portion 23. Thus, since a separate supporting jig (not illustrated) is not required when the fusion-coupling part 40 and the liner part 10 are fusion-coupled to each other, productivity can be significantly improved.

Further, both ends of the liner part 10 may be in close contact with and coupled to the stepped portion 22a formed to be stepped in the boundary region between the boss flange portion 22 and the boss support portion 23. Thus, the liner part 10 and the boss flange portion 22 may be formed to have a mutually continuous outer contour. In addition, since the fusion-coupling part 40 is supported by the boss support portion 23, leakage of the fluid between the liner part 10 and the fusion-coupling part 40 is minimized even when an external force is applied, and the sealing performance can be significantly improved.

That is, both ends of the liner part 10 are in close contact with and coupled to the lower outer edge of the boss flange portion 22, and at the same time, the fusion-coupling part 40 is supported by the boss support portion 23. Thus, even when an external force is applied from the outside of the liner part 10, a state in which both inner circumferences of the liner part 10 are fusion-coupled to the fusion-coupling part 40 is maintained, the leakage of the fluid can be minimized, and the sealing performance can be significantly improved.

Further, in the related art, the liner parts were divided and welded to each other. On the other hand, in the present disclosure, both inner circumferences of the liner part 10 are fusion-coupled to the outer circumference of the fusion-coupling part 40 insert-injected in a form surrounding the boss support portion 23. Thus, the liner part 10 may be manufactured in various lengths without limitation, and thus economic efficiency can be significantly improved.

The present disclosure provides the following effects.

First, when a fusion-coupling part and a liner part insert-injected in a form surrounding a boss support portion are fusion-coupled to each other, an inner circumference of the fusion-coupling part is supported by the boss support portion extending from an inner end of a boss flange portion, and thus a separate supporting jig is not required so that productivity can be significantly improved.

Second, both ends of the liner part are in close contact with and coupled to a stepped portion formed to be stepped in a boundary region between the boss flange portion and the boss support portion to form a continuous outer contour, the fusion-coupling part is supported by the boss support portion, and thus even when an external force is applied, leakage of a fluid between the liner part and the fusion-coupling part can be minimized, and sealing performance can be significantly improved.

Third, unlike the related art in which the liner part is divided and is mutually welded, both inner circumferences of the liner part are fusion-coupled to an outer circumference of the fusion-coupling part insert-injected in a form surrounding the boss support portion, and thus the liner part can be manufactured in various lengths without limitation, and economic efficiency can be significantly improved.

In this case, the above-described terms such as “includes,” “constitutes,” or “has” mean that the corresponding component may be inherent unless otherwise stated, and thus should be construed as not excluding other components but further including other components. All terms including technical or scientific terms have the same meanings as those commonly understood by those skilled in the art to which the present disclosure pertain unless otherwise defined. The generally used terms defined in the dictionaries should be construed as having the meanings that coincide with the meanings of the contexts of the related technologies, and should not be construed as ideal or excessively formal meanings unless clearly defined in the present disclosure.

As described above, the present disclosure is not limited to the above-described respective embodiments, modifications could be made by those skilled in the art to which the present disclosure pertains without departing from the range of the present disclosure claimed by the appended claims, and the modifications belong to the scope of the present disclosure.

What is claimed is:

1. A pressure vessel comprising:
a boss part including a boss extension portion that is provided in a cylindrical shape and has a fastening screw thread formed on an outer circumference thereof, a boss flange portion integrally extending radially outward in a circumferential direction from a lower portion of the boss extension portion, and a boss support portion integrally extending downward in a longitudinal direction from an inner end of the boss flange portion, and having a through-hole formed in a central portion thereof in the longitudinal direction;
a fusion-coupling part insert-injected in a form surrounding an outer surface of one side of the boss support portion in the circumferential direction; and
a liner part which has an accommodation space for accommodating a fluid therein, extends in a longitudinal direction, and has both open sides and in which both ends of the liner part are in close contact with and coupled to a lower outer edge of the boss flange portion, both inner circumferences of the liner part face with a gap therebetween and are inserted into an outer circumference of the boss support portion, the liner part is made of the same material as the fusion-coupling part, and both inner circumferences of the liner part are in surface contact with and fusion-coupled to an outer circumference of the fusion-coupling part.

2. The pressure vessel of claim 1, wherein a stepped portion is formed to be stepped in a boundary region between the boss flange portion and the boss support portion, and
the boss support portion integrally extends in a longitudinal direction of the liner part to be parallel to the liner part from the inner end of the boss flange portion.

3. The pressure vessel of claim 2, wherein the stepped portion is formed along the lower outer edge of the boss flange portion such that the liner part and the boss flange portion are formed to have a mutually continuous outer contour, and a radial length of the stepped portion is set to correspond to a thickness of the liner part.

4. The pressure vessel of claim 1, wherein a recessed groove is formed in the boss support portion to be recessed radially inward from an outer circumference in the circumferential direction, and
the fusion-coupling part is formed with a shape engagement protrusion that protrudes radially inward in a circumferential direction to mesh with the recessed groove.

5. The pressure vessel of claim 1, wherein a length of the boss support portion is set to exceed a length of the fusion-coupling part, and
a catching protrusion is formed at a lower end of the boss support portion to extend radially outward in the circumferential direction with a thickness corresponding to the fusion-coupling part such that a lower end of the fusion-coupling part is caught by and coupled to the catching protrusion.

6. The pressure vessel of claim 1, wherein the boss part includes a sealing coupling portion integrally extending downward from the boss support portion in a longitudinal direction, having an outer circumference facing and spaced apart from the inner circumferences of the liner part, and having an interior with which the through-hole communicates,
a sealing groove is formed in an outer circumference of the sealing coupling portion to be recessed radially inward in the circumferential direction, and
the pressure vessel further comprises a sealing part which is provided in a ring shape and of which an inner circumference is inserted into the sealing groove and an outer circumference is sealing-coupled to the inner circumferences of the liner part.

7. The pressure vessel of claim 6, wherein a sealing stepped portion which protrudes radially outward in the circumferential direction and of which an outer circumference faces the inner circumferences of the liner part is formed at a lower end of the sealing coupling portion.

8. The pressure vessel of claim 6, wherein the sealing part is provided as a plurality of sealing parts that are sealing-coupled to the sealing groove while in close contact with each other in a longitudinal direction of the sealing coupling portion, and
a sum of thicknesses of the sealing parts in a longitudinal direction is set to correspond to a length of the sealing groove.

9. The pressure vessel of claim 1, wherein the liner part is provided with a color having a higher brightness than the fusion-coupling part.

10. A pressure vessel comprising:
a boss part including a boss extension portion that is provided in a cylindrical shape and has a fastening screw thread formed on an outer circumference thereof, a boss flange portion integrally extending radially outward in a circumferential direction from a lower portion of the boss extension portion, a boss support portion integrally extending downward in a longitudinal direction from an inner end of the boss flange portion, and a sealing coupling portion integrally extending downward from the boss support portion in the longitudinal direction and having a sealing groove formed on an outer circumference of the sealing coupling portion to be recessed radially inward in the circumferential direction, and having a through-hole formed in a central portion thereof in the longitudinal direction;
a fusion-coupling part insert-injected in a form surrounding an outer surface of one side of the boss support portion in the circumferential direction;
a liner part which has an accommodation space for accommodating a fluid therein, extends in a longitudinal direction, and has both open sides and in which both ends of the liner part are in close contact with and coupled to a lower outer edge of the boss flange portion, both inner circumferences of the liner part face with a gap therebetween and are inserted into an outer circumference of the boss support portion, the inner circumferences of the liner part face and are spaced apart from an outer circumference of the sealing coupling portion, the liner part is made of the same material as the fusion-coupling part, and both inner circumferences of the liner part are in surface contact with and fusion-coupled to an outer circumference of the fusion-coupling part;
a sealing part which is provided in a ring shape and of which an inner circumference is inserted into the sealing groove and an outer circumference is sealing-coupled to the inner circumferences of the liner part; and
a composite cover part that is sealing-coupled to an outer circumference of the liner part while surrounding outer surfaces of the boss extension portion and the boss flange portion.
